(19) United States
(12) Patent Application Publication
(10) Pub. No.: US 2011/0156293 A1
(43) Pub. Date: Jun. 30, 2011

(54) EMBOSSING ASSEMBLY, MANUFACTURING METHOD THEREOF, AND EMBOSSING METHOD USING THE SAME

(75) Inventors: DA-WEI LIN, Tu-Cheng (TW); HSI-CHANG WU, Tu-Cheng (TW)

(73) Assignee: HON HAI PRECISION INDUSTRY CO., LTD., Tu-Cheng (TW)

(21) Appl. No.: 12/822,313

(22) Filed: Jun. 24, 2010

(30) Foreign Application Priority Data
Dec. 24, 2009 (TW) 98144652

(51) Int. Cl. G02B 1/12; B28B 11/08; C25D 5/48

(52) U.S. Cl. 264/1.27; 425/385; 205/95

(57) ABSTRACT

A light guide plate is manufactured by applying an embossing assembly. The embossing assembly includes a roller and an embossing layer applied on the roller. The embossing assembly is formed by electroforming embossing micro-structures on the outer surface of the embossing layer to an embossing substrate and embossing micro-structures on a surface thereof.

### CROSS-REFERENCE TO RELATED APPLICATION

This application is related to a co-pending U.S. patent application Ser. No. 12/758,128, filed on Apr. 128, 2010, and entitled “EMBOSSING ASSEMBLY, MANUFACTURING METHOD THEREOF, AND EMBOSSING METHOD USING THE SAME”. The inventors of the co-pending application are Hsi-Chang Wu and Tai-Cherng Yu. The co-pending application has the same assignee as the present application. The Specification and Drawings of the co-pending application are incorporated herein by reference.

### BACKGROUND

1. Technical Field

The present disclosure generally relates to an embossing assembly, a method of manufacturing the embossing assembly, and a method of embossing light guide plates using the embossing assembly.

2. Description of Related Art

Backlight modules are critical components of a liquid crystal display, such as those used in a mobile phone or digital camera. A commonly used backlight module generally includes a light guide plate to optimize optical properties. A typical method of manufacturing the light guide plate includes forming a plurality of micro-structures on a die by precision cutting, and employing the die to form the light guide plate by insert-molding. However, the insert-molding process provides only limited manufacturing efficiency, and sprue material is unavoidably generated during the insert-molding process, indicating material waste.

A roll-to-roll process is often used to fabricate the light guide plate, providing improvements in both manufacturing efficiency and manufacturing cost. A roller for embossing arrays of structural features on a substrate, such as a plurality of micro-structures, rolls on and embosses the substrate to imprint a plurality of micro-structures thereon. Generally, the roller is provided with a plurality of micro-structures formed on the outer surface thereof. The micro-structures are commonly formed by die cutting the roller surface employing precision machine cutting. However, since the roller is substantially cylindrical, when the light guide plate to be formed has a plurality of complex micro-structures, the corresponding micro-structures on the roller are difficult to be formed by machine cutting and relatively costly.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of one embodiment of an embossing assembly.

FIG. 2 is a flowchart of one embodiment of a method of manufacturing an embossing assembly, such as, for example, that of FIG. 1.

FIG. 3 shows a manufacturing process for forming the embossing assembly of FIG. 1.

FIG. 4 is a flowchart of one embodiment of a method of manufacturing a light guide plate employing the embossing assembly of FIG. 1.

### DETAILED DESCRIPTION

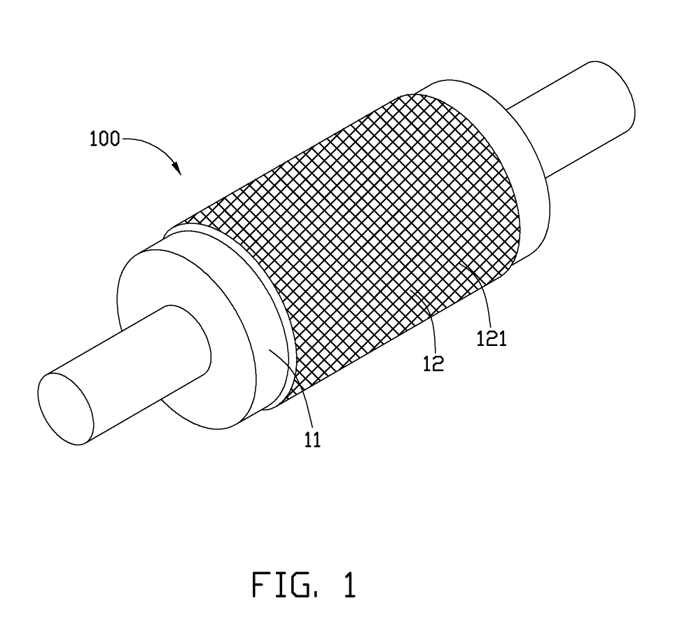

Referring to FIG. 1, one embodiment of an embossing assembly 100 includes a roller 11 and an embossing layer 12 applied on the roller 11. The embossing layer 12 can be formed by electroforming and includes a plurality of embossing micro-structures 121 formed on an outer surface of the embossing layer 12. The embossing micro-structures 121 are rigid and arranged in a matrix. The embossing micro-structures 121 may be substantially drop point-shaped, prism, protrusion or groove extending along a curve, or combination thereof. When the embossing layer 12 is rolled on a substrate, a plurality of micro-structures is formed on the substrate corresponding to the embossing micro-structures 121.

The roller 11 may be made of a thermally conductive material, such as aluminum, copper, zinc, nickel, iron, titanium, cobalt or an alloy thereof. The embossing layer 12 may be made of a thin flexible layer of electroforming material, such as nickel, platinum-nickel-cobalt, cobalt-tungsten, gold or silver.

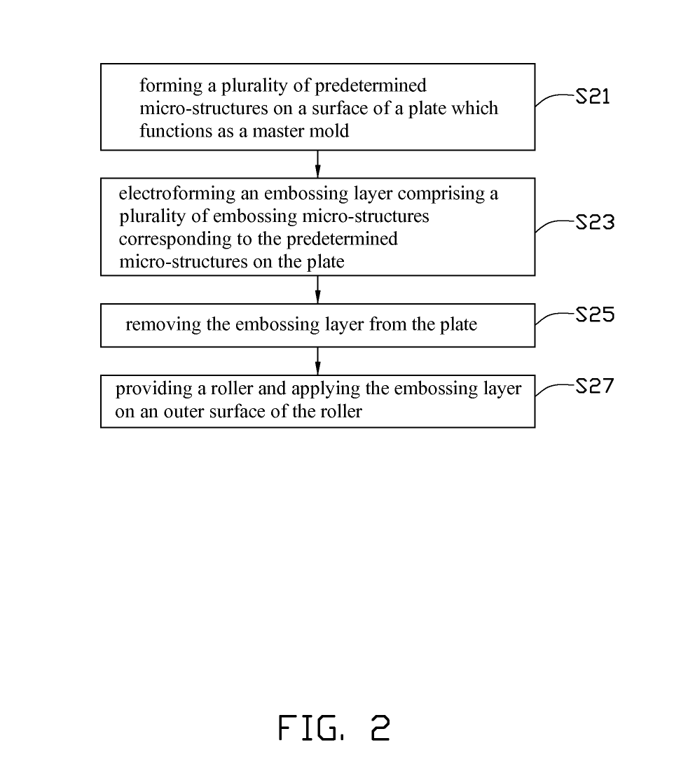

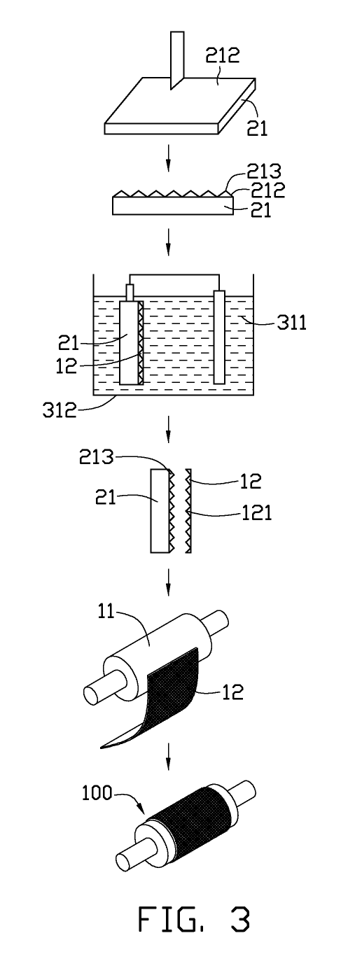

Referring to FIGS. 2 and 3, one embodiment of a method of manufacturing the embossing assembly 100 is described as follows.

In step S21, a plurality of predetermined micro-structures 213 is formed on a surface 212 of a plate 21 which functions as a master mold for electroforming.

The plate 21 can be made of plastic, stainless steel, paraffin or aluminium alloy. The plate 21 may be rectangular and the surface 212 of the plate 21 flat, thus facilitating the position of the plate 21 when forming the predetermined micro-structures 213. The predetermined micro-structures 213 are arranged in a matrix and may be formed by machine cutting employing a multiple spindle machine tool, laser etching, laser carving or casting. Because the predetermined micro-structures 213 are formed on a flat surface 212, a complex structure with lower manufacturing cost can be easily achieved. The predetermined micro-structures 213 formed on the plate 21 may be substantially reverse drop point-shaped, reverse prism, protrusion or groove extending along a curve.

In step S23, an embossing layer 12 with a plurality of embossing micro-structures 121 thereon is electroformed together with the plate 21 functioning as a master mold.

During the electroforming process, the plate 21 with the predetermined micro-structures 213 thereon is placed in an electrolytic bath 312 containing an electrolytic solution 311. A thin coating layer is deposited on the surface 212 of the plate 21 to form an embossing layer 12. A plurality of embossing micro-structures 121 is formed on a surface of the embossing layer 12 that is adjacent to and touches the plate 21. The embossing micro-structures 121 correspond to the predetermined micro-structures 213 on the plate 21. The embossing layer 12 may be a thin flexible layer of nickel, platinum-nickel-cobalt, cobalt-tungsten, gold or silver.

In step S25, the electroformed embossing layer 12 is detached from the plate 21. An oxidation film or graphite layer can be formed on the surface 212 of the plate 21 to facilitate removal of the embossing layer 12.

In step S27, a roller 11 is provided, and the embossing layer 12 is applied on the outer surface of the roller 11. The embossing layer 12 is secured to the roller 11 by welding, rivets, or other means.

Because a complex embossing micro-structures 121 can be easily formed by the disclosed method, corresponding complex micro-structures on the light guide plate can be formed by the embossing layer 121, thus improving the optical properties of the light guide plate.

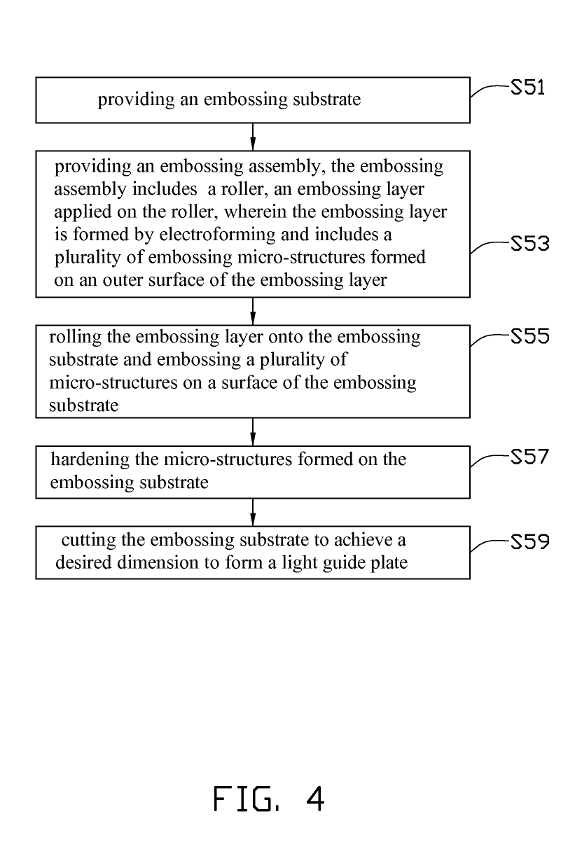

Referring to FIG. 3 and FIG. 4, one embodiment of a method of manufacturing a light guide plate is described as follows. The method employs a roll-to-roll process to emboss a plurality of micro-structures.

In step S51, an embossing substrate is provided. The embossing substrate may be a flexible thin sheet. A resin layer may be coated on a surface of the embossing substrate. The embossing substrate may be preheated before embossing.

In step S53, the embossing assembly 100 as disclosed is provided.

In step S55, the embossing layer 12 of the assembly 100 is rolled onto the embossing substrate and imprints a plurality of micro-structures corresponding to the embossing micro-structures 121 on a surface thereof. The micro-structures formed on the embossing substrate may be substantially reverse drop point-shaped, reverse prism, protrusion or groove extending along a curve matching the embossing micro-structures 121.

In step S57, the micro-structures embossed on the embossing substrate are hardened. The micro-structures can be hardened by UV radiation or heat.

In step S59, the embossing substrate with micro-structures formed thereon is cut to achieve a desired dimension to form a light guide plate (not shown).

The disclosed method allows continuous embossing of the light guide plate, thus achieving a higher manufacturing efficiency and lower cost. The disclosed method using a roll-to-roll process further avoids generation of sprue material, thus reducing material waste.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An embossing assembly, comprising:
a roller; and
an embossing layer applied on the roller, wherein the embossing layer is formed by electroforming a plurality of embossing micro-structures on the outer surface of the embossing layer.

2. The embossing assembly of claim 1, wherein the embossing layer is a thin layer of nickel, platinum-nickel-cobalt, cobalt-tungsten, gold or silver.

3. The embossing assembly of claim 1, wherein each of the plurality of embossing micro-structures is substantially drop point-shaped.

4. The embossing assembly of claim 1, wherein each of the plurality of embossing micro-structures is substantially a prism.

5. The embossing assembly of claim 1, wherein each of the plurality of embossing micro-structures is substantially a protrusion or a groove extending along a curve.

6. A method of manufacturing an embossing assembly, comprising:
forming a plurality of predetermined micro-structures on a surface of a plate, wherein the plate functions as a master mold;
electroforming an embossing layer comprising a plurality of embossing micro-structures corresponding to the plurality of predetermined micro-structures on the plate;
removing the embossing layer from the plate; and
providing a roller and applying the embossing layer on an outer surface of the roller.

7. The method of manufacturing an embossing assembly of claim 6, wherein the surface of the plate with predetermined micro-structures thereon is substantially flat.

8. The method of manufacturing an embossing assembly of claim 6, wherein the predetermined micro-structures on the plate are formed by machine cutting.

9. The method of manufacturing an embossing assembly of claim 6, wherein the predetermined micro-structures on the plate are formed by casting, laser etching or laser carving.

10. The method of manufacturing an embossing assembly of claim 6, wherein the embossing layer is made of nickel, platinum-nickel-cobalt, cobalt-tungsten, gold or silver.

11. The method of manufacturing an embossing assembly of claim 6, wherein the plate is made of plastic, stainless steel, paraffin or aluminium alloy.

12. The method of manufacturing an embossing assembly of claim 6, wherein each predetermined micro-structure on the plate is substantially reverse drop point-shaped, reverse prism, protrusion or groove extending along a curve corresponding to the embossing micro-structures formed on the embossing layer.

13. A method of manufacturing a light guide plate, comprising:
providing an embossing substrate;
providing an embossing assembly, the embossing assembly comprising:
a roller;
an embossing layer applied on the roller, wherein the embossing layer is formed by electroforming and comprises a plurality of embossing micro-structures formed on the outer surface of the embossing layer; and
rolling the embossing layer onto the embossing substrate and embossing a plurality of micro-structures on a surface of the embossing substrate.

14. The method of manufacturing a light guide plate of claim 13, wherein each of the plurality of embossing micro-structures on the embossing layer is substantially drop point-shaped.

15. The method of manufacturing a light guide plate of claim 13, wherein each of the plurality of embossing micro-structures on the embossing layer is substantially a prism.

16. The method of manufacturing a light guide plate of claim 13, wherein each of the plurality of embossing micro-structures on the embossing layer is substantially a protrusion or groove extending along a curve.

17. The method of manufacturing a light guide plate of claim 13, further comprising hardening the micro-structures formed on the embossing substrate by UV (ultraviolet) radiation.
